(19) United States
(12) Patent Application Publication
(10) Pub. No.: US 2007/0048483 A1
(43) Pub. Date: Mar. 1, 2007

(54) Radiation image-able data storage medium

(76) Inventors: Douglas G. Stinson, Fremont, CA (US); Abhirup De, Birbhum (IN); Rajeev Jindal, Noida (IN); Subrata Dutta, Delhi (IN); Brian Bartholomeusz, Palo Alto, CA (US); Giriraj Nyati, Noida (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/214,609

(22) Filed: Aug. 29, 2005

(51) Int. Cl. B32B 3/02

(52) U.S. Cl. 428/64.1

(57) ABSTRACT

A radiation image-able data storage medium according to one exemplary embodiment is provided in the present disclosure that includes a substrate having at least one diffractive feature formed on a surface of the substrate. The radiation image-able data storage medium may also include a radiation-sensitive layer that may be coupled to the substrate.

### BACKGROUND

Data storage media provide a convenient way to store large amounts of data in stable and mobile formats. For example, optical discs, such as compact discs or other discs, allow a user to store relatively large amounts of data in a single place. Data on such discs often includes entertainment, such as music and/or images, as well as other types of data. In the past, consumer devices were read only. In other words, devices were configured to read the data stored on such devices and the devices were not configured to store data thereon. Data was frequently placed on the disc by way of a large commercial machine that burned the data onto the disc. In order to identify the contents of the disc, commercial labels were frequently printed onto the disc by way of screen printing or other similar methods.

Recent efforts have been directed to providing disc burning or writing capabilities to consumers. Such efforts include the use of drives that are configured to burn recordable compact discs, rewritable compact discs, recordable digital video discs, and/or rewritable digital video discs to name a few. These drives provide a convenient way for users to record relatively large amounts of data that may then be easily transferred or used in other devices.

The data storage mediums, such as digital video discs or other such mediums, frequently have two sides: a data side and a label side. The data side contains data that is burned into the medium. Current methods have also been directed to selectively form images on the label side. For example, one approach for the labeling of recordable and rewritable DVDs includes applying a radiation-sensitive coating to the label side of the disc. When exposed to an intense electromagnetic source, such as a focused laser in a DVD writer, the layer changes color.

In particular, the region or area of the radiation-sensitive coating located at the focus of a laser beam absorbs some fraction of the applied light. This forms the primary image. Some fraction of the light passes through the sensitive layer, is reflected by an underlying layer, and returns to the radiation-sensitive layer. Frequently, as the laser beam returns, it expands, but it is still sufficiently intense to create an image, albeit one of lower intensity. The unintended or undesired secondary imaging surrounding the primary image area may be referred to as “halo effect”. Many users find the resulting image quality unacceptable.

### SUMMARY

A radiation image-able data storage medium includes a substrate having at least one diffractive feature formed on a surface of the substrate, and a radiation-sensitive layer coupled to the substrate.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a schematic view of a media processing system according to one exemplary embodiment.

FIG. 2 is a cross sectional view of a radiation image-able data storage medium according to one exemplary embodiment.

FIG. 3 illustrates an array of diffractive features formed on a surface according to one exemplary embodiment.

FIG. 4 illustrates radiation exposure pattern due to diffraction of electromagnetic radiation by the array of diffractive features, according to one exemplary embodiment.

FIG. 5 is a flowchart illustrating a method of forming an radiation image-able storage medium, according to one exemplary embodiment.

FIG. 6 is a cross sectional view of a radiation image-able data storage medium according to one exemplary embodiment.

Throughout the drawings, identical reference numbers designate similar, but not necessarily identical, elements.

### DETAILED DESCRIPTION

Radiation image-able discs are provided herein that are configured to have data stored on one side thereof and to have images formed on an opposite or label side. The image is formed on the label side in a radiation-sensitive layer that includes a color forming composition. The color forming composition is exposed by exposure to electromagnetic radiation with a sufficient power density. When such electromagnetic radiation is incident on the radiation-sensitive layer, the color forming composition absorbs sufficient electromagnetic radiation and is developed or changes color. The label side includes diffractive features that reduce undesired or unintended exposure of the color forming composition due to light that is transmitted through the radiation sensitive layer and is reflected back thereto by underlying layers of the radiation image-able disc. The undesired or unintended exposure of the radiation-sensitive layer outside a primary image area may be referred to as halo effect. By providing diffractive features on one or more surfaces of the second substrate, a substantially symmetrical structure may be maintained, thus minimizing the possibility of warp or distortion of the radiation image-able disc. Further, such radiation image-able discs can be produced using existing manufacturing equipment used to produce commercially available disc formats.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Schematic View of a Media System

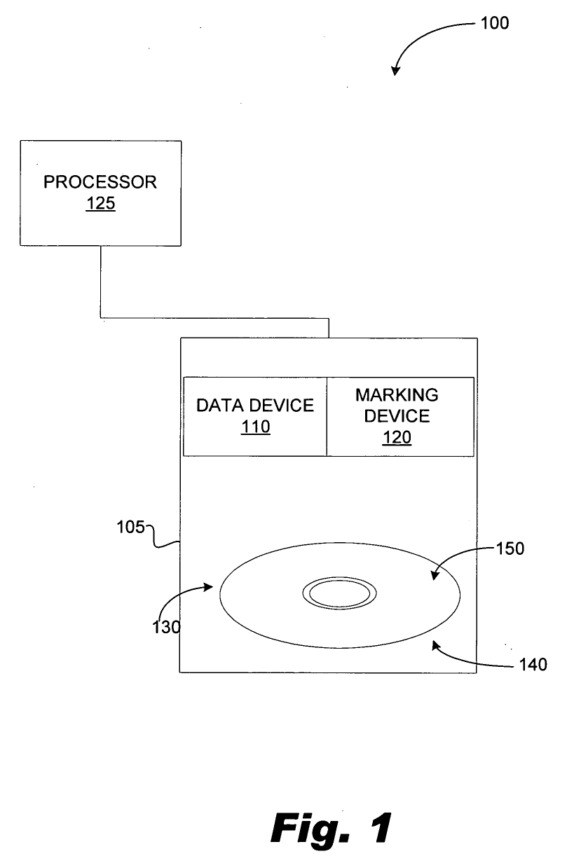

FIG. 1 illustrates a schematic view of a media processing system (100). As will be described in more detail below, the media processing system (100) allows a user, among other things, to have stored on a radiation image-able data storage medium (radiation image-able disc) and to have a graphic image selectively established thereon.

Exemplary radiation image-able discs encompass audio, video, multi-media, and/or software disks that are machine readable in a CD and/or DVD drive, or the like. Examples of radiation image-able disc formats include writeable, recordable, and rewriteable disks such as DVD, DVD-R, DVD-RW, DVD+R, DVD+RW, DVD-RAM, CD, CD-ROM, CD-R, CD-RW, and the like. Other like formats may also be included, such as similar formats and formats to be developed in the future.

The media processing system (100) shown includes a housing (105) that houses a data device (110) and a marking device (120) coupled to a processor (125). While separate devices are shown, those of skill in the art will appreciate that a single device may be used to provide the functions of the data device (110) and the marking device (120). The operation of both the data device (110) and the marking device (120) may be controlled by the processor (125). The media processing system (100) also includes hardware for placing the radiation image-able disc (130) in a position to be read by the data device (110) and/or marked by the marking device (120). The operation of the hardware may also be controlled by the processor (125).

The processor (125) shown is separate from the media processing system (100), according to one exemplary embodiment. Exemplary processors (125) may include, without limitation, a computer or other such device. The processor (125) may have software or other drivers residing thereon configured to control the operation of the data device and the marking device to selectively read and/or write data to the radiation image-able disc (130). Those of skill in the art will understand that any suitable processor may be used, including a processor configured to reside on the media processing system.

As introduced, the data device (110) and the marking device (120) are each configured to interact with the radiation image-able disc (130). In particular, the exemplary radiation image-able disc (130) includes first and second opposing sides (140, 150) with a reflective data surface formed therebetween. The first side (140) includes a transparent substrate that allows the media processing system (100) that protects the reflective data surface while providing access thereto for the media processing system (100).

With respect to the first side (140), the data device (110) may be configured to read data stored on the data device (110) and/or to store data on the radiation image-able disc (130). As used herein, “data” is typically used with respect to the present disclosure to include the non-graphic information contained on the radiation image-able disc that is digitally or otherwise embedded therein. Data can include audio information, video information, photographic information, software information, and the like. Alternatively, the term “data” may also be used to describe the information a computer or other processor uses to draw from in order to form a graphic display on the radiation image-able surface of the second side (150).

As will be discussed in more detail below, the marking device (120) is configured to selectively apply electromagnetic radiation to the radiation image-able surface to thereby form a graphic display thereon. As used herein, “graphic display” can include any visible character or image found on an optical disk. Typically, the graphic display is found prominently on one side of the optical disk, though this is not always the case. By selectively marking the surface of the second side (150), the marking device (120) may thus be configured to form a “label” on the second side.

The second side (150) has a radiation image-able surface formed thereon. The second side (150) includes a protective substrate and a radiation-sensitive layer. As will be discussed in more detail below, the protective substrate includes diffractive features on one or more surfaces of the protective substrate. The marking device (120) is configured to direct concentrated radiation to the second side (150), to thereby selectively form images thereon.

Frequently, some portion of the concentrated radiation will pass through the radiation-sensitive layer. The concentrated radiation passes through the protective substrate. The radiation is then reflected back to the radiation-sensitive layer. The diffractive features disperse the concentration of radiation as the radiation is directed back to the radiation-sensitive layer. By thus reducing the concentration of the radiation reflected back to the radiation-sensitive layer, the diffractive features reduce undesired imaging by the radiation, as will be discussed in more detail below.

Radiation Image-Able Data Storage Medium

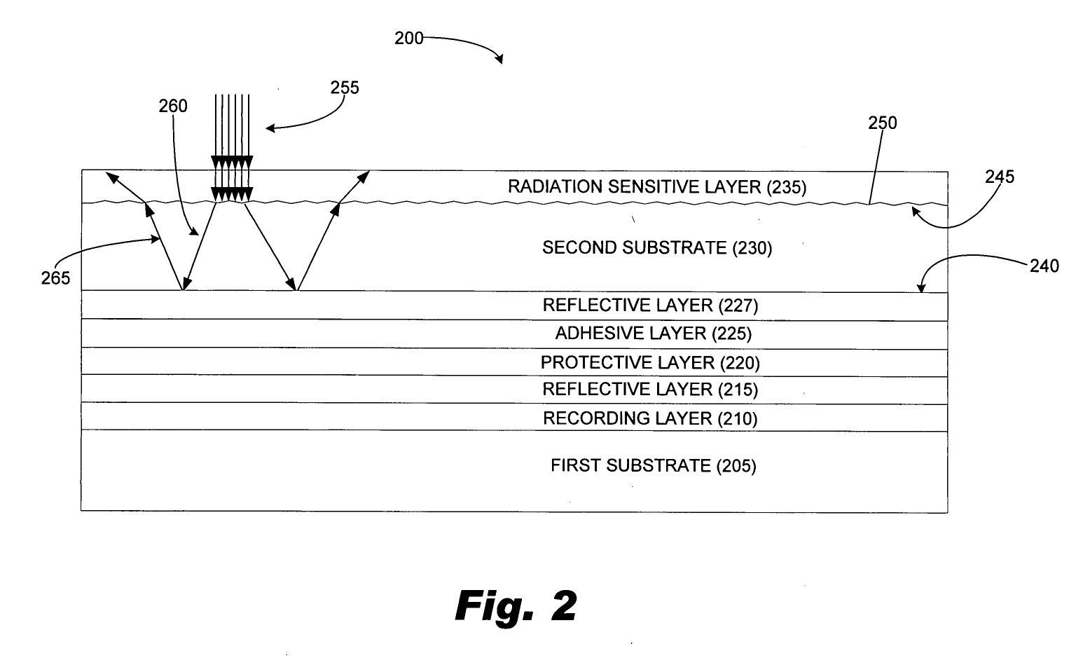

FIG. 2 illustrates partial cross sectional view of a radiation image-able data storage medium (radiation image-able disc) (200). As seen in FIG. 2, the radiation image-able disc includes a first substrate (205), a recording layer (210), a first reflective layer (215), a protective layer (220), an adhesive layer (225), a second reflective layer (227), a second substrate (230), and a radiation-sensitive layer (235). As will be discussed in more detail below, the second substrate (230) has at least one surface with diffractive features included thereon that reduce halo effect.

The recording layer (210) may include one or more layers of photosensitive dye. According to such an embodiment, unexposed dye may be generally translucent, such that radiation, such as laser light, passes through the recording layer and is reflected by the first reflective layer (215). A radiation source, such a laser, may selectively apply radiation to expose the photosensitive dye at desired locations. At such locations, the developed dye may become non-reflective. By selectively exposing portions of the recording layer (210), reflective and non-reflective portions may thus be formed in the recording layer. Each reflective and non-reflective portion may be associated with a corresponding binary data type. For example, reflective portions may be designated as 1's and the non-reflective portions as 0's or vice versa. Thus, by selectively forming reflective and non-reflective portions in the recording layer, data may be stored on the radiation image-able disc (200).

In addition to storing data, the radiation image-able disc is configured to have an image formed on the radiation-sensitive layer (235). In particular, an image may be formed by applying electromagnetic radiation to the radiation-sensitive layer (235). According to one exemplary embodiment, the radiation-sensitive layer (235) includes a thermally activated color forming composition. In order to form an image, radiation is directed to desired locations on the radiation-sensitive layer (235).

Upon application of suitable electromagnetic radiation, such as in the form of laser light, the color forming composition is heated sufficiently to develop the color former. In particular, the color forming composition absorbs radiation and is thereby heated. The degree to which the color forming composition changes color may depend, at least in part, on the amount of heat absorbed by the color forming composition. The amount of heat absorbed at a given location in the radiation-sensitive layer (235) by the color forming composition depends, at least in part, on the concentration of the electromagnetic radiation directed thereto. For example, a relatively concentrated electromagnetic radiation will cause a larger color change than a relatively diffused electromagnetic radiation. Thus, focused or high intensity electromagnetic radiation is directed to a location where such a color change is desired.

Frequently, some portion of the electromagnetic radiation applied to the radiation-sensitive layer (235) passes through the radiation-sensitive layer (235), through the second substrate (230), and to the second reflective layer (227). The second reflective layer (227) reflects this transmitted radiation back through the second substrate (230) and to the radiation-sensitive layer (235).

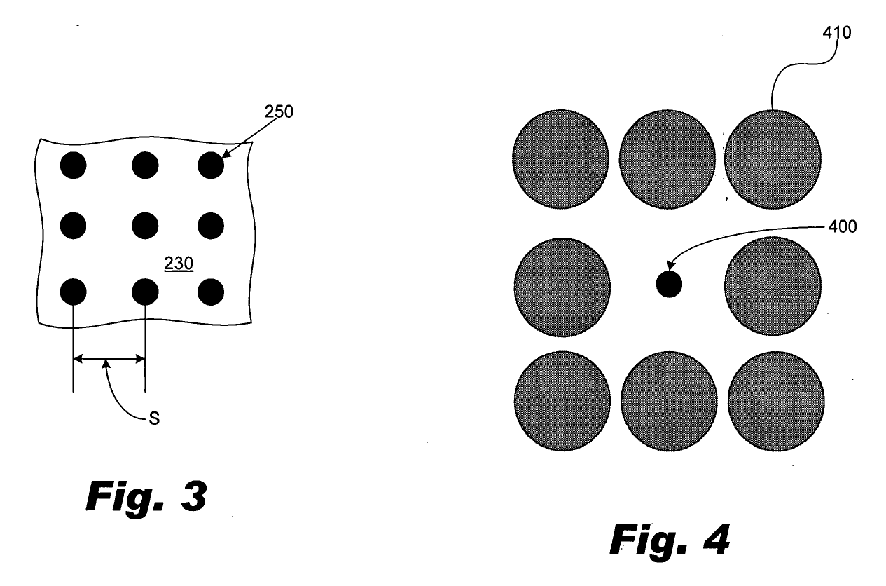

The second substrate (230) includes diffractive features formed on at least one surface thereof that reduce the concentration of radiation reflected back to the first surface (240) and a second surface (245). At least one of the first and second surfaces (240, 245) includes diffractive features formed thereon. According to one exemplary embodiment, the second surface (240) includes such diffractive features formed thereon. Such features are shown in more detail in FIG. 3.

According to the present exemplary embodiment, the second surface (240) includes a plurality of diffractive features (250). The diffractive features may form an array of pits or grooves.

As introduced, the radiation-sensitive layer (235) includes a color forming composition that changes color when it absorbs sufficient radiation. For ease of reference, laser light (255) will be discussed as the type of applied radiation. Those of skill in the art will appreciate that other types of electromagnetic radiation may be used to form an image or images in the radiation-sensitive layer (235).

In operation, laser light (255) is directed to the radiation image-able disc (200) to selectively form an image thereon. The surface of the radiation-sensitive layer (235) covered by laser light (255) may correspond to the intended or desired area to be colored by the application of the laser light (255). The portion of the radiation-sensitive layer (235) on which the focused laser light (255) is incident may be referred to as the primary image area. A portion of the laser light (255) is absorbed by the radiation-sensitive layer (235), thereby causing a portion of the radiation-sensitive layer (235) to heat up and change color, as previously discussed. Some of the laser light not absorbed by the radiation-sensitive layer (235) will pass through the primary image area, where it will then be incident on the second surface (245) of the second substrate (230), which includes the diffractive features (250). The light transmitted through the primary image area may be referred to as transmitted laser light (260).

As the transmitted laser light (260) passes into the second substrate (230), the diffractive features (250) diffract the transmitted laser light (260), thereby causing the transmitted laser light (250) to become divergent. As the now divergent transmitted laser light (250) is incident on the first surface (240) and the second reflective layer (227), the transmitted laser light (250) is incident on a larger area than that corresponding to the primary image area.

A substantial portion of the transmitted laser light (250) will be reflected by the second reflective layer (227) and back through the second substrate (230). The light reflected back through the second substrate (230) may be referred to as reflected laser light (265). According to one exemplary embodiment, the interface between the first surface (240) and the corresponding surface of the second reflective layer (227) may be substantially featureless, such that the interface is substantially flat.

In general, light or other waves incident on a surface have an angle of incidence, which is measured relative to a line perpendicular to the point of incidence. The reflected light is reflected away with an angle of reflection. The angle of reflection is also measured from the line perpendicular to the point of incidence. If the surface is generally flat, the angle of incidence and angle of reflection will be the same.

Returning to the transmitted laser light (260), as the transmitted laser light (260) is incident on the flat interface, the reflected laser light (265) has an angle of reflection equal to the angle of incidence. The reflected laser light (265) is reflected back through the second substrate (230) where it is incident on the radiation-sensitive layer (235).

As introduced, the diffractive features (250) cause the beams of the transmitted laser light (260) to diverge, thereby causing the beams to be incident on a larger area. As the beams are reflected, the reflected laser light (265) becomes more divergent relative to the transmitted laser light (260). By spreading the transmitted light over a large area, the concentration of the reflected laser light (265) at a given location is thus decreased.

As previously discussed, the degree of color change or development of the color forming composition in the radiation-sensitive layer (235) depends, at least in part, on the concentration of the radiation directed thereto. Accordingly, reducing the concentration of the reflected laser light (265) incident on the radiation-sensitive layer (235) reduces the degree of color change in response to the absorption of reflected laser light (265). Thus, the diffractive features (250) reduce the undesired color change in the radiation-sensitive layer (235) outside of the primary image area due to reflected laser light (265).

In particular, FIG. 3 is a top view of the second surface (230) illustrating an array of diffractive features (250). According to one exemplary embodiment, the diffractive features (250) have a depth defined by the equation:
D=λ(1/4+1/2n)
where D is the depth of the diffractive feature, A is the wavelength of the applied radiation, and n is an integer. For example, laser light having a wavelength of approximately 780 nm may be used to form images on the radiation-sensitive layer (235; FIG. 2). According to such an embodiment, it may be desirable to have features with depths in the range of 195 nm.

The total amount of light diffracted away from the perpendicular, may depend, at least in part, on the ratio of the surface area occupied by the features to the total area of the radiation-sensitive layer (235). Suitable ratios that may help reduce halo may be greater than zero and less than one, such as a ratio of about 0.5.

The actual direction of transmitted laser light (260) that is diffracted by the diffractive features (250) will be determined by the spacing between the diffractive features (250). A relatively close spacing between diffractive features, will cause the laser light to be diffracted through a greater angle. Any spacing may improve the halo effect. According to one exemplary embodiment, the spacing may be defined by the equation:
S<λ/A
where S is the spacing between diffractive features, λ is the wavelength of the incident electromagnetic radiation, and A is the numerical aperture of the lens used to focus the laser onto the radiation image-able disc (200).

Such spacing between diffractive features may help to minimize the overlap between the incident light and the reflected light. According to one exemplary embodiment, laser light with a wavelength of about 780 nm laser is focused onto the radiation image-able disc (200) by a lens with a numerical aperture of approximately 0.45, such that the spacing is less than about 1.73 micrometers.

Accordingly, the diffractive features (250) reduce the development of the color forming composition outside the primary image area. For example, FIG. 4 illustrates a primary radiation distribution pattern (400) and diffusive radiation distribution patterns (410) on the radiation-sensitive layer (235; FIG. 2). The primary radiation distribution pattern (400) corresponds with the primary image area discussed above. The diffusive radiation distribution patterns (410) are formed by the reflected laser light (265; FIG. 2).

Each diffusive radiation distribution pattern (410) is formed by a portion of the laser light not absorbed in the radiation-sensitive layer. Accordingly, the power density associated with each diffusive radiation distribution pattern (410) is substantially less than that associated with the primary image area. The reduced power density associated with each diffusive radiation distribution pattern (410) reduces the possibility that the color forming composition in that region will thus be developed. By thus reducing the development of the color forming composition outside the primary image area, a primary image may be formed with reduced halo effect.

Formation of a Radiation Image-able Disc with Diffractive Features

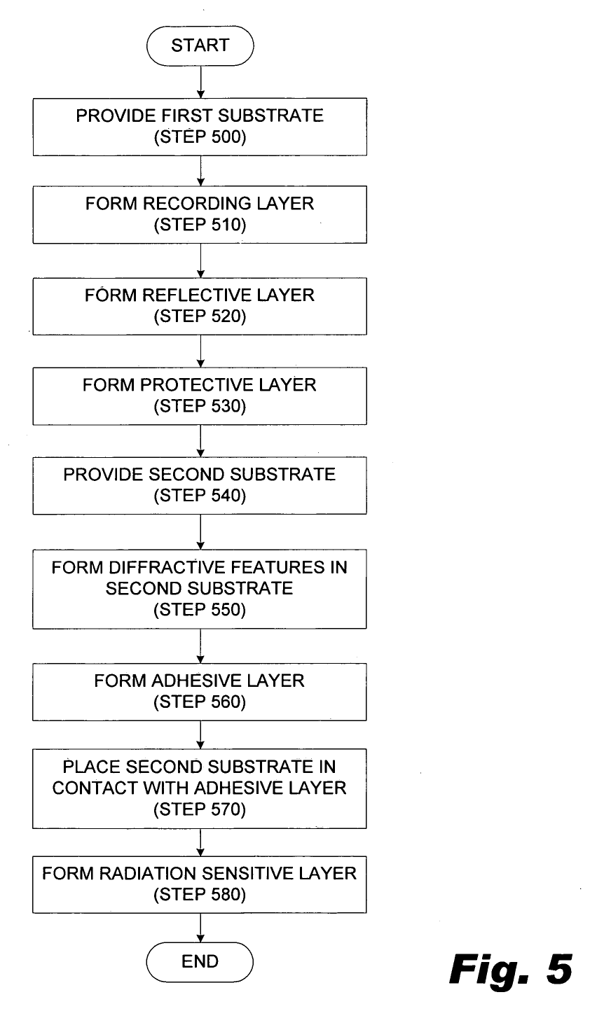

FIG. 5 illustrates a method of forming a radiation image-able disc with diffractive features. While certain steps are described herein, those of skill in the art will appreciate that the steps may be performed in different order and/or steps may be omitted. The present exemplary method begins by providing a first substrate (step 500). According to one exemplary embodiment, the first substrate includes a polycarbonate substrate, such as a 0.6 mm thick layer of polycarbonate.

A recording layer is then formed on the first substrate (step 510). The recording layer may include one or more layer of photosensitive material, such as dye, which is initially transparent or translucent. A reflector layer is then formed on the recording layer (step 520). According to one exemplary method, the reflector layer may include a thin layer of silver, aluminum, gold, or other suitable metal. A protective layer may then be formed on the reflective layer (step 530).

A second substrate is then provided (step 540). The second substrate may be substantially similar to the first substrate or may be different. At least one array of diffractive features is formed on at least one surface of the second substrate (step 550). As discussed above, according to one exemplary method, the formation of diffractive features may include the formation of pits or grooves. According to one exemplary method, the surface having the diffractive features formed thereon is opposite a generally featureless surface. The generally featureless surface may be secured to the protective layer, such as forming an adhesive layer on the protective layer (step 560) and placing the second substrate in contact with the adhesive layer (step 570). According to one exemplary embodiment, the featureless surface of the second substrate is placed in contact with the adhesive layer. While a second substrate with diffractive features on the outer surface has been described, diffractive features may be formed on either the inner portion and/or the outer portion.

A radiation-sensitive layer is formed on the outer surface of the second substrate (step 580). According to one exemplary method, the radiation-sensitive layer is deposited on the diffractive features. The radiation-sensitive layer includes a color forming composition that is configured to develop or change color in response to when it absorbs sufficient electromagnetic radiation. According to such an embodiment, the diffractive features diffract unabsorbed electromagnetic radiation that is incident thereon. As a result, the diffractive features reduce the undesired or unintended development of the color forming composition due to unabsorbed electromagnetic radiation that is transmitted through the radiation-sensitive layer. According to one exemplary embodiment discussed above, the diffractive features are on the outer surface of the second substrate. Other configurations are possible, one of which will now be discussed in more detail below.

### Alternative Embodiment

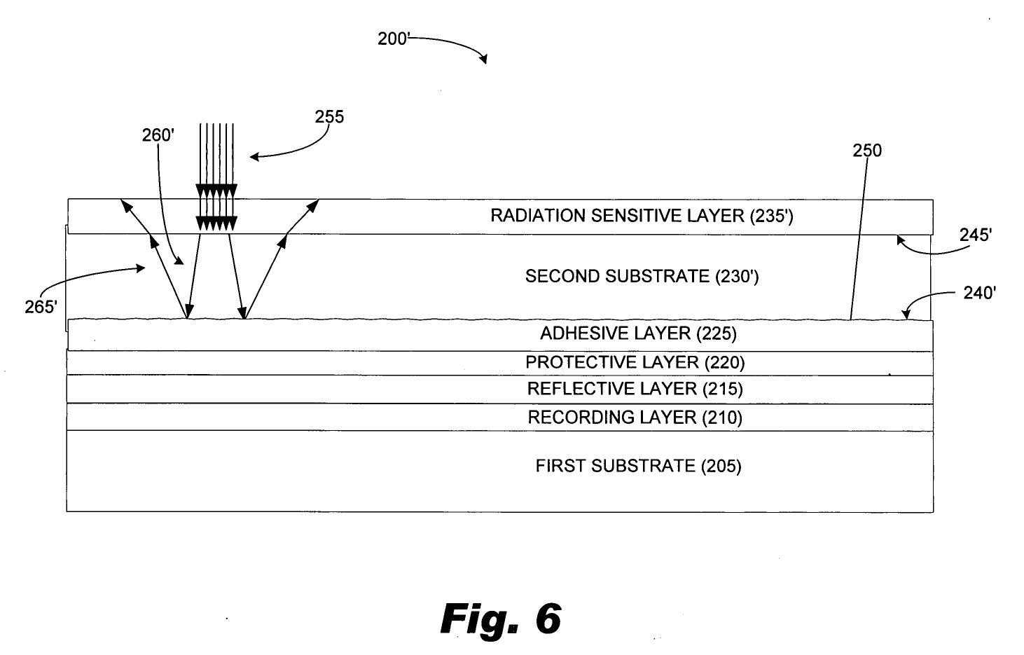

FIG. 6 illustrates a cross sectional view of a radiation image-able disc (200′) that includes a second substrate (230′) with diffractive features (250′) formed on a first surface (240′), which is the inner surface of the second substrate (230′). According to such an exemplary embodiment, the second surface (245′) may be generally featureless, or may include additional diffractive features formed thereon, as shown in FIG. 3. For ease of reference, a generally featureless second surface (245′) will be discussed.

A radiation-sensitive layer (235′) is formed on the second surface (245′) of the second substrate. As previously discussed, when electromagnetic radiation, such as laser light, is directed to the radiation-sensitive layer (235′), some portion of the laser light will be absorbed by a color forming composition in the radiation-sensitive layer (235′).

If the electromagnetic radiation has sufficient power density, the color forming composition absorbs sufficient electromagnetic radiation to be developed and change color. Some of the non-absorbed electromagnetic radiation is transmitted through the radiation-sensitive layer (235′) and the second substrate (230′) where it is incident on the first surface (240′) and the diffractive features (250′).

According to one exemplary embodiment, the spacing of the diffractive features (250′) on the first surface may be defined the equation:
S<λ/2A
where S is the spacing between diffractive features, λ is the wavelength of the incident electromagnetic radiation, and A is the numerical aperture of the lens used to focus the laser onto the radiation image-able disc (200′). Further, the depth of each diffusive feature may be similar to the diffractive features (250′) discussed above.

The diffractive features (250′) diffract transmitted laser light (260′) that is incident thereon as it is reflected back toward the radiation-sensitive layer (235′). As the reflected laser light (265′) is directed back to the radiation-sensitive layer (235′), the power density of the light incident on the radiation-sensitive layer (235′) is reduced, thereby decreasing halo effect, as previously discussed.

In conclusion, radiation image-able discs are provided herein that are configured to have data stored on one side thereof and to have images formed on an opposite or label side. The image is formed on the label side in a radiation-sensitive layer that includes a color forming composition. The color forming composition is exposed by exposure to electromagnetic radiation with a sufficient power density. When such electromagnetic radiation is incident on the radiation-sensitive layer, the color forming composition absorbs sufficient electromagnetic radiation and is developed or changes color. The label side includes diffractive features that reduce undesired or unintended exposure of the color forming composition due to light that is transmitted through the radiation-sensitive layer and is reflected back thereto by underlying layers of the radiation image-able disc. The undesired or unintended exposure of the radiation-sensitive layer outside a primary image area may be referred to as halo effect. By providing diffractive features on one or more surfaces of the second substrate, a substantially symmetrical structure may be maintained, thus minimizing the possibility of warp or distortion of the radiation image-able disc. Further, such radiation image-able discs can be produced using existing manufacturing equipment used to produce commercially available disc formats.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A radiation image-able data storage medium, comprising:
a substrate having at least one diffractive feature formed on a surface of said substrate; and
a radiation-sensitive layer coupled to said substrate.

2. The radiation image-able data storage medium of claim 1, wherein said diffractive feature includes a pit formed in said substrate.

3. The radiation image-able data storage medium of claim 1, and further comprising a plurality of diffractive features formed in said surface.

4. The radiation image-able data storage medium of claim 3, wherein said surface is an outer surface of said radiation image-able data storage medium.

5. The radiation image-able data storage medium of claim 3, wherein central portions of said diffractive features are spaced at a distance less than a quantity corresponding to a wavelength of electromagnetic radiation used to develop said radiation-sensitive layer divided by a numerical aperture of a lens used for focusing said electromagnetic radiation.

6. The radiation image-able data storage medium of claim 3, wherein said diffractive features have a depth of approximately the quantity one fourth plus an integer multiple of one half all multiplied by a wavelength of electromagnetic radiation used to develop the radiation-sensitive layer.

7. The radiation image-able data storage medium of claim 3, wherein said surface is an inner surface of said radiation image-able data storage medium.

8. The radiation image-able data storage medium of claim 3, wherein central portions of said diffractive features are spaced at a distance less than a quantity corresponding to a wavelength of electromagnetic radiation used to develop said radiation-sensitive layer divided by approximately two times a numerical aperture of a lens used for focusing said electromagnetic radiation.

9. The radiation image-able data storage medium of claim 1, wherein said substrate comprises a label side substrate and further comprising a data side substrate, a recording layer, first and second reflective layers, a protective layer, and an adhesive layer.

10. The radiation image-able data storage medium of claim 9, wherein said label side substrate and said data side substrate include a polycarbonate material.

11. The radiation image-able data storage medium of claim 10, wherein said polycarbonate material is approximately 0.6 mm thick.

12. A method of forming a data storage medium, comprising:
forming at least one array of diffractive features on a surface of a substrate; and
forming a radiation-sensitive layer on said substrate.

13. The method of claim 12, and further comprising preliminary steps of determining a wavelength of electromagnetic radiation to be directed to said radiation-sensitive layer, and determining a spacing and depth of said diffractive features based at least in part on said wavelength.

14. The method of claim 13, wherein determining said spacing includes determining a numerical aperture of a lens to be used to direct said electromagnetic radiation to said radiation-sensitive layer and dividing said wavelength by said numerical aperture.

15. The method of claim 13, wherein determining said spacing includes determining a numerical aperture of a lens to be used to direct said electromagnetic radiation to said radiation-sensitive layer and dividing said wavelength by two times said numerical aperture.

16. The method of claim 13, wherein determining said depth includes multiplying said wavelength by the quantity one fourth plus an integer multiple of one half.

17. The method of claim 12, wherein forming said diffractive features on said substrate include forming said diffractive features on an inner portion of said substrate.

18. The method of claim 12, wherein forming said diffractive features on said substrate include forming said diffractive features on an outer portion of said substrate.

19. A data storage medium, comprising:
data storing means for storing data;
image forming means for selectively forming an image; and
diffractive means for reducing a power density of electromagnetic radiation transmitted through and reflected back to said image forming means.

20. The data storage medium of claim 19; wherein said image forming means includes a color forming composition.

21. The data storage medium of claim 19, wherein said data storing means and said image storing means are formed on opposing sides of said data storage medium.
